(19) United States
(12) Patent Application Publication
(10) Pub. No.: US 2008/0203157 A1
(43) Pub. Date: Aug. 28, 2008

(54) STORAGE AND TRANSPORT MECHANISM FOR A SELF-SERVICE CARD KIOSK WITH RETURN AND REISSUE CAPABILITY

(75) Inventors: Peter THORSEN, Prior Lake, MN (US); Harry Dale OLSON, Watertown, MN (US)

Correspondence Address: HAMRE, SCHUMANN, MUELLER & LARSON, P.C., P.O. BOX 2902, MINNEAPOLIS, MN, 55402-0902, US

(73) Assignee: DATACARD CORPORATION, Minneapolis, MN (US)

(21) Appl. No.: 11/470,911

(22) Filed: Sep. 7, 2006

(51) Int. Cl. G06K 5/00

(52) U.S. Cl. 235/382

(57) ABSTRACT

Improved mechanisms are described for use in an automated, self-service machine that is used to issue a card or other object to an individual, and allow return of the card or other object by the individual for later automated re-issuance of the card or object to the same or different individual. The mechanisms allow the machine to issue a card or object to a user, allow return of the card or object back into the machine, and later reissue of the card or object to the same or different user.

### FIELD

This disclosure relates to a self-service machine that issues an object to a user, and allows return of the object for later reissuance to another user. In particular, the disclosure relates to a self-service card issuing machine that is configured to issue a card to a user, allows the return of the card back into the machine, and later reissuing of the card to the same or different user. The machine can be used in a number of applications, including usage with an access control system that controls access into and throughout a building(s).

### BACKGROUND

An access control system is often used to manage access to premises such as buildings, rooms, laboratories, and building complexes. Persons allowed to enter the premises are provided badges which comprise a machine-readable element such as a magnetic strip, a microprocessor and/or a wireless transponder. Badge readers and automatic doors located throughout the premises that read the badges are connected to the access control system. The access control system maintains a registry of badge identifiers associated with persons such as regular personnel, contractors and visitors, and allows a person access to specific localities of the premises depending on access rights associated with that person's badge.

Many premises assign security personnel or other individuals the task of manning a building entry point, authenticating employees as they enter and/or leave the premises and distributing badges to new employees or current employees who have lost their badges, authenticating and controlling contractor access to the premises, collecting visitor information and entering that information into a permanent record, clearing visitors for entry to the premises and distributing badges to visitors, and other related tasks. Often times, at busy entry points, a number of personnel are needed in order to manage the flow of people. This is labor intensive, can lead to security lapses, and can create delays in processing people in and out of the premises. In addition, this method is not effective for premises where there is not sufficient room for a reception area or other entry point, where a plurality of entry/exit points exist, where there are too few employees or visitors to justify assigning an individual to this task, or for operation outside normal working hours.

U.S. Patent Application Publication 2003/0058082 discloses an automated system that is described as being used for providing visitor badges. The described system does not appear to be capable of providing employee badges. In addition, the system appears to lack the capability of allowing the return of, and later reissuance of, the visitor badges.

U.S. Pat. No. 7,029,009 discloses a playing card dealing shoe with an automated internal card feeding and card reading mechanism. The described mechanism has a first area for receiving a set of cards; a card mover that moves a card from the first area to a temporary card storage area; a card reading sensor; and another card mover that moves a card from the temporary card storage area to a card delivery area wherein the card may be removed from the card dealing shoe by a user. The described system does not appear to be capable of having multiple and separate types of cards. In addition, the mechanism appears to lack the capability of allowing the return of, and later reissuance of, the cards.

### SUMMARY

Improved mechanisms are described for use in an automated, self-service machine that is used to issue a card or other object to an individual, and allow return of the card or other object by the individual for later automated re-issuance of the card or object to the same or different individual. The mechanisms allow the machine to issue a card or object to a user, allow return of the card or object back into the machine, and later reissue of the card or object to the same or different user.

The machine can be used in a number of applications, including with an access control system that controls access into and throughout a building(s). The machine can be configured to dispense temporary re-usable badges to employees, contractors, and visitors. The badges can be returned to the machine, which stores the returned badges for later re-issuance to a later user needing a temporary badge. The machine can also integrate with an enterprise access control system that controls access to a number of dispersed building sites.

The machine described herein can reduce the amount of personnel needed for use in controlling access to buildings, and can reduce the workload of personnel that are present by allowing people needing a badge to use a self-service machine. Further, the self-service machine can reduce the time spent by employees, contractors and visitors in acquiring and returning the temporary badges. The self-service machine also allows personnel other than designated entry or security point personnel to register, verify identification, obtain and return badges for visitors. In addition, the self-service machine provides a record of badge transactions, leading to more accurate and complete badge security.

In one embodiment, an object storage and transport mechanism for use in an automated, self-service machine, includes a first mechanism configured to store a plurality of objects, and a second mechanism configured to transport objects between the first mechanism and a discharge location. The first and second mechanisms are operable together in at least two modes, including a retrieval mode and a return mode. When in the retrieval mode, the second mechanism retrieves an object from the first mechanism and transports the retrieved object to the discharge location, and when in the return mode the second mechanism returns an object from the discharge location to the first mechanism.

In another embodiment, an apparatus for issuing, allowing return of, and re-issuing an object, includes a housing with a user interface, an opening in the housing through which an object is dispensed to and returned by a user, a storage area within the housing configured to store a plurality of objects, and a transport mechanism configured to transport an object between the storage area and the opening to issue an object from the storage area through the opening and to permit return of the object from the opening back to the storage area.

In still another embodiment, a machine for issuing, allowing return of, and re-issuing a card, includes a housing, an issue and return opening formed in the housing, a card storage mechanism disposed within the housing and configured to store a plurality of cards, and means for transporting a card from the card storage mechanism to the issue and return opening to issue a card through the issue and return opening, and for transporting a returned card from the issue and return opening back into the card storage mechanism for later reissuing.

### DRAWINGS

FIG. 1 illustrates a perspective view of one embodiment of a self-service card issuing machine of the invention.

FIG. 2 illustrates one embodiment of a local access control system using one embodiment of a self-service card issuing machine.

FIG. 3 is a schematic illustration of the process of dispensing a reusable card.

FIG. 4 is a schematic illustration of the process of a card being returned to the card issuing machine.

FIG. 5 illustrates a schematic side section of one embodiment of an object storage and transport mechanism.

FIG. 6 illustrates a top view of the storage and transport mechanism.

FIG. 7 illustrates a front view of the storage mechanism.

FIG. 8 illustrates a perspective view of the storage mechanism.

### DETAILED DESCRIPTION

Improved mechanisms for issuing a card or other object to an individual, and allow return of the card or other object by the individual for later automated reissuance of the card or object to the same or different individual are described in the following description. The mechanisms can be used in a number of applications, including in a self-service machine that is used with an access control system to control access into and throughout a building(s). Objects that can be issued include, but are not limited to, cards and key fobs. Cards include, but are not limited to, badges used for access control to and within buildings or secured areas, debit cards and gift cards. The cards can be, for example, CR 80 size cards. The cards are made of materials, for example plastic, that allow the cards to maintain their integrity over repeated uses. To facilitate the description, the inventive concepts will hereinafter be described with respect to the object being a badge used for building access control. However, it is to be realized that the inventive concepts apply to issuing other objects as well, and to applications other than access control in a building, for example to machines that issue and receive reloadable objects such as gift cards.

The badges are preferably non-personalized without user specific information, permanent printing or a user photograph added to the badge. Each badge is temporary for a user. The badge is intended to be returned for later automated reissuance of the badge the same or different individual. The badges are issued by a self-service issuing machine that is configured to issue a badge to a user, allow return of the badge back into the machine where it is stored and later reissued to the same or different user.

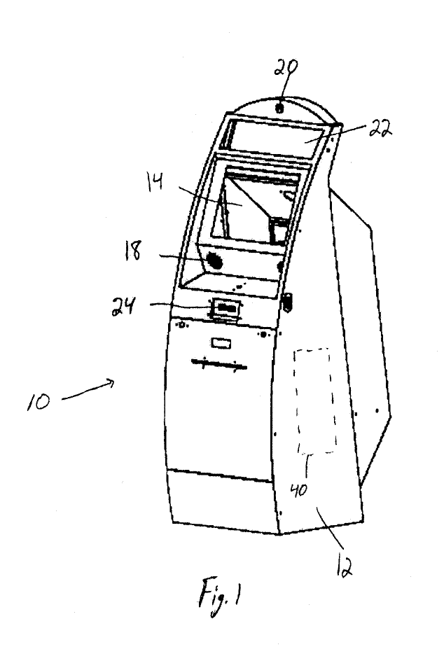

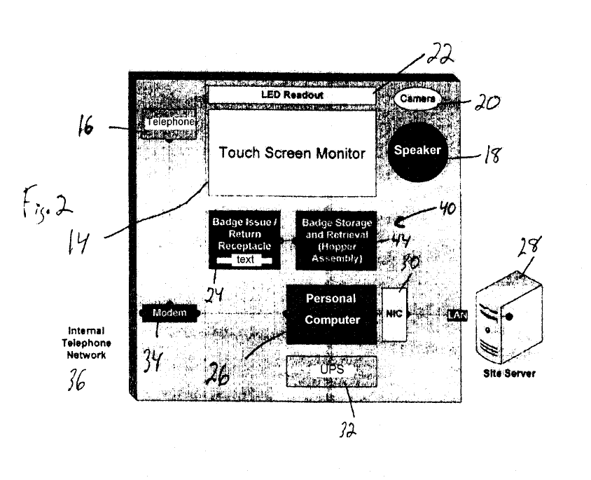

With reference to FIG. 1, an embodiment of a self-service badge issuing machine 10 is illustrated. The machine 10 comprises a housing 12 that includes one or more user interfaces, for example a touch screen monitor 14, accessible from the exterior of the housing 12 to allow a user to interact with the machine 10 and display user prompts and information. The touch screen monitor 14 preferably permits entry of user commands and user data and information. One or more other user interfaces could be used in place of or in addition to the touch screen monitor 14, for example a key board, a mouse, a telephone 16 (shown schematically in FIG. 2), and others.

The machine 10 may also includes other exterior components including a speaker 18 to permit audio communications to be communicated to a user, for example by a security person at a security desk, a camera 20 which can take pictures or video of the user and the machine surroundings which can be stored within the machine 10 and/or relayed to a remote station for viewing or storage. In addition, the machine 10 may include an LED readout 22 for displaying various messages to the user.

In addition to the above described externally accessible components, the machine 10 includes a badge dispensing/return slot 24, forming a retrieval and return area, through which badges are dispensed to users and returned by users to the machine 10. The slot 24 is illustrated as being in front of the machine 10 beneath the touch screen monitor 14, but could be located at any convenient location on the machine 10.

With reference to FIG. 2, a computer 26 that has a processor, memory for data storage, and a user interface such as a keyboard, is disposed within the interior of the machine 10. The computer 26 is in communication with an external site server 28 via a network interface card 30 and a local area network. The site server 28 can be located in the same building or the same complex of buildings as the machine 10, and contains computer programs and configuration data for operating the machine and a site database containing data on possible users of the machine, such as employee and contractor data. The site server 28 can also control an access control system within the building or complex of buildings. An uninterruptible power supply 32 supplies power to the machine 10 which is plugged into a conventional wall socket via a power cord.

A modem 34 within the machine 10 is connected to the computer 26 and the telephone 16, and is connected to an internal telephone network 36. The modem 34 permits a user to telephone employees or other persons within the building or complex of buildings served by the machine, via the telephone 16 and the internal telephone network 36. Instructions for using the telephone 16 can be displayed on the touch screen monitor 14 along with a list of employees and associated telephone numbers provided via the computer 26 and the site server 28.

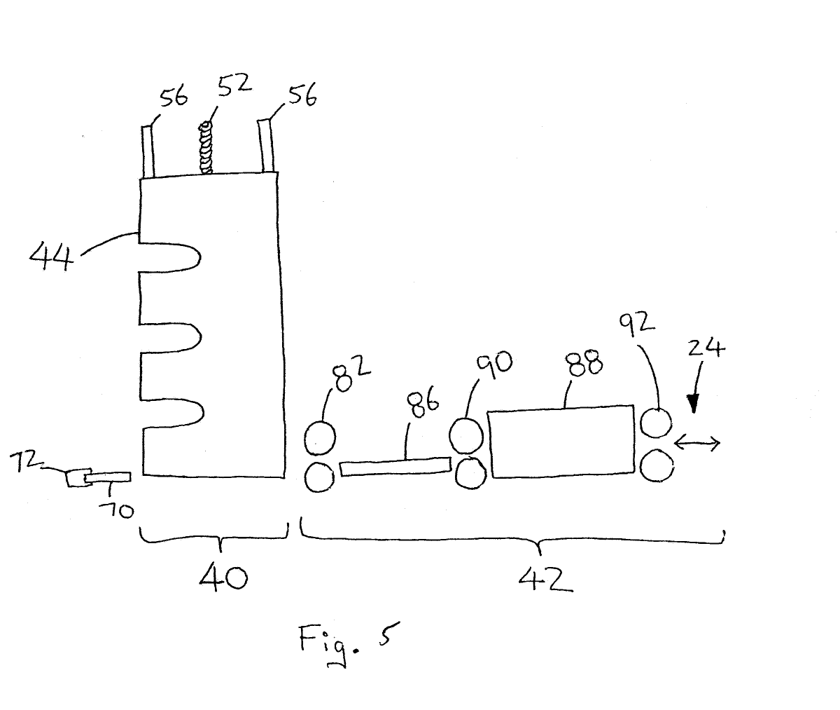

Also internal to the machine is a storage mechanism 40 and a transport mechanism 42. With reference to FIGS. 2 and 5-8, the mechanisms 40, 42 are mounted so as to be movable relative to one another. For example, in the embodiment described and illustrated herein, the storage mechanism 40 is movable and the transport mechanism 42 is fixedly mounted. Alternatively, the storage mechanism 40 could be fixedly mounted and the transport mechanism 42 could be mounted so as to move relative to the storage mechanism 40. In another alternative, both the storage mechanism 40 and the transport mechanism 42 could both be movable.

With reference to FIGS. 2 and 5-8, one embodiment of a storage mechanism 40 comprises a badge storage and retrieval hopper assembly 44 that is mounted for vertical movement relative to the transport mechanism 42 within the machine. It will be appreciated that in other embodiments of a storage mechanism, rather than moving vertically, the hopper assembly 44 may be mounted for horizontal movement, rotational movement, or any combinations thereof. The hopper assembly 44 is designed to discharge cards one at a time through a front side 46 thereof to the transport mechanism 42, and to receive returned cards one at a time through the front side 46 from the transport mechanism 42.

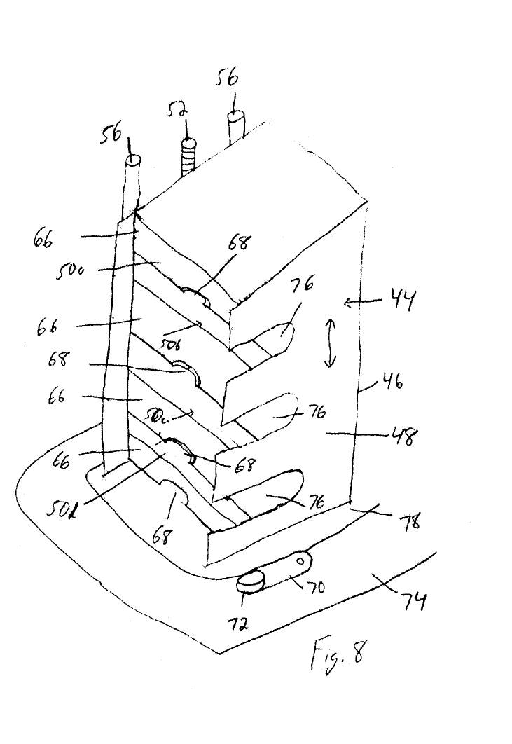

The hopper assembly 44 includes a hopper housing 48 that is configured to hold a plurality of cards. The hopper housing 48 can define a single card storage area or, more preferably, define a plurality of separate card storage locations 50a, 50b, 50c, 50d as shown in FIGS. 7 and 8. The use of separate card storage locations permits the storage of different types of badges, thereby allowing different types of badges to be dispensed. For example, storage location 50a can store employee badges, storage location 50b can store contractor badges, while storage location 50c can store visitor badges. In addition, the hopper housing can include a storage location 50d for rejected cards, including cards that cannot be read by the sensor mechanism (to be later described). If desired, the different types of badges can contain indicia, for example colors, to indicate the different types of badges. For example, an employee badge can be color coded green, a contractor badge color coded blue, and a visitor badge color coded red. Other indicia on the cards to distinguish different types of card can also be used.

The hopper housing 48 is driven vertically by a lead screw 52 that is rotatably driven by a reversible motor (not shown) and a threaded nut 54 that is fixed to the housing 48. A pair of guide posts 56 and slide bearings 58 fixed to the housing 48 that slide on the posts 56 help guide the housing 48 during its vertical movements. It will be appreciated that rather than using a lead screw and threaded nut to drive the hopper housing vertically, any number of different means may be used to move the hopper housing 48 relative to the transport mechanism 42, such as belts, chains, pullies and gears, or other variations thereof readily apparent to those of skill in the art.

With reference to FIG. 7 which shows the front side of the hopper housing 48, each of the storage locations 50a, 50b, 50c, 50d includes an exit slot 60 defined in a front wall 62 thereof through which a card from the bottom of the card stack in the storage location exits the storage location when being dispensed. The exit slot 60 has a width that is slightly greater than the width of the cards to allow the cards to travel through the slot 60. Each storage location 50a, 50b, 50c, 50d also includes a return opening 64 generally above the front wall 62 through which a returned card is returned into the storage location to the top of the card stack.

FIG. 8 shows the back side of the hopper housing 48. The back side of each storage location 50a, 50b, 50c, 50d is closed off by a wall 66. A notch 68 is formed at the bottom of each wall 66 thereby exposing the rear edge of the lowermost card in each card stack. A pivotable actuating arm 70 supporting an actuating protrusion 72 is mounted on a stationary structure 74 to the side of the hopper housing 48 and adjacent the back side thereof. In addition, slots 76 associated with the storage locations 50a, 50b, 50c are cut-out in the side of the hopper housing 48. When discharging a card, the actuating arm 70 and protrusion 72 are rotatable into a respective slot 76, with the protrusion 72 engaging the rear edge of the card exposed by the notch 68 to drive the card out the respective exit slot 60 at the front side 46 of the hopper housing 48. For the reject hopper 50d, the arm 70 extends beneath the side wall of the hopper housing instead of rotating into a slot.

The hopper housing 48 is actuatable vertically up and down through an opening 78 in the stationary structure 74 by rotating the lead screw 52 in the appropriate direction. It will of course be appreciated that rather than moving vertically, the hopper housing may be actuatable horizontally, rotatably or any combinations thereof. When it is desired to discharge a card from one of the storage locations, for example storage location 50c, the hopper housing 48 is lowered until the exit slot 60 thereof is aligned with the transport mechanism 42. At this position the slot 76 is level with the actuating arm 70. The arm 70 is then rotated to bring the protrusion 72 into engagement with the rear edge of the card exposed by the notch 68 in order to drive the card forwardly into the transport mechanism 42. When it is desired to return a card to the storage location 50c, the hopper housing 48 is lowered until the return opening 64 is aligned with the transport mechanism 42. The transport mechanism 42 then directs the card through the return opening 64 and back on top of the card stack within the storage location 50c for later reissuance.

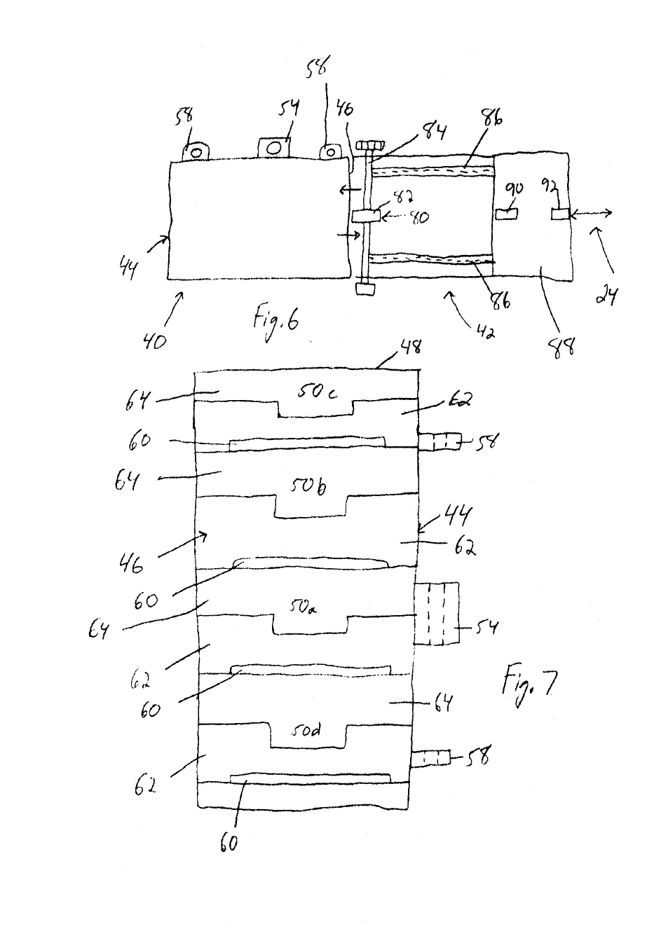

Returning to FIG. 6, the transport mechanism 42 includes a drive roller assembly 80 that is adjacent the front side 46 of the hopper housing 48. The drive roller assembly is responsible for picking up a card that is driven through one of the exit slots 60 and driving the card toward the discharge slot 24, and receiving returned cards and driving the cards into the respective storage location. The drive roller assembly 80 preferably comprises upper and lower rollers 82 (only the upper roller 82 is shown) mounted on respective drive shafts 84 (only the upper drive shaft 84 is shown) driven by a reversible motor (not shown).

The transport mechanism 42 also includes guide rails 86 that guide the edges of the card. A discharged card is guided by the guide rails 86 to a sensor assembly 88 that includes a sensor for reading a unique identifier on the card. The type of sensor will depend on how the identifier is stored on the card. The unique identifier can be formed by numbers, letters, symbols, pictures, holograms, or combinations thereof, a bar code or any other means of forming an identifier that is unique to the card. The identifier can be coded or uncoded. The identifier can be disposed in any suitable form on the badge, such as by printing, disposed in a magnetic stripe, disposed in an integrated circuit chip embedded in or on the badge, or attached to a substrate (for example a label) that is attached to the badge. If the identifier is stored on a magnetic stripe of the card, the sensor will be a magnetic stripe reader for reading the magnetic stripe. If the identifier is stored on a chip embedded in the card, the sensor will be a chip reader suitable for reading the chip. If the identifier is stored in bar code form, the sensor will be a bar code reader. Other forms of identifiers and sensors can be used.

The sensor assembly 88 also includes roller assemblies 90, 92 which transport the cards to the discharge slot 24, and receive returned cards through the discharge slot for return to the storage area 40.

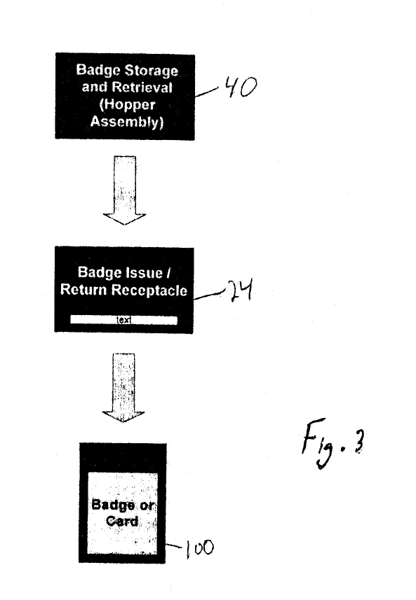

As shown in FIG. 3, a card 100 is dispensed from the machine 10 to a user by discharging a card from the storage area 40, and transporting the card by the transport mechanism 42 to the slot 24. Prior to being dispensed through the slot 24, the unique identifier on the card is read by the sensor of the sensor assembly 88, and the identifier is transmitted to the site server 28 where the identifier is associated with the user who is logged into the machine 10.

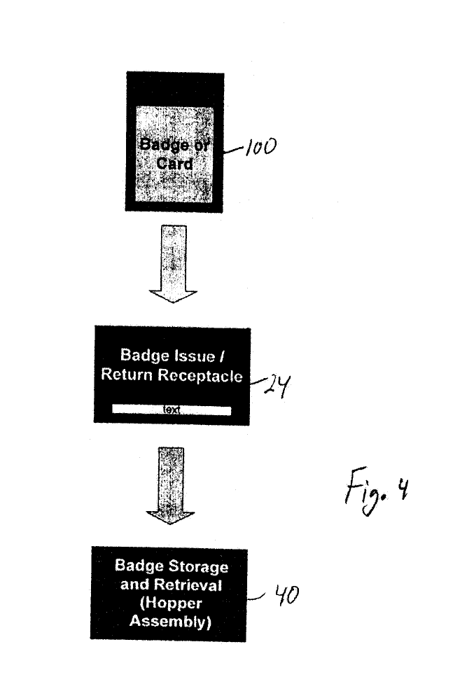

When the card is no longer needed by the user, the user can return the card to the machine 10 by logging on and returning the card through the slot 24 as shown in FIG. 4. The returned card is picked up by the rollers, and the unique identifier read by the sensor of the sensor assembly 88. In this way, the system knows which card has been returned by which individual and the site server 28 can delete the associated links between the returned card and the user. The returned card is then transported back to the storage area for return into the appropriate location of the hopper housing 48. The returned card can then be dispensed to a new user in need of a badge, with the unique identifier of the card being reassigned to the new user upon dispensing the card. In the case where the unique identifier of the card cannot be read, it is returned to the user. If the user does not take the card within a predetermined amount of time, the card is transported to the reject storage location 50d. In addition, if a user inserts a different form of card that is not recognized by the machine, for example the user inserts a credit card, the machine 10 will withdraw the card back into the machine 10 after presenting the card for the user to pick-up, and direct the card to the reject storage area 50d in order to prevent a later user from obtaining the credit card.

The invention may be embodied in other forms without departing from the spirit or novel characteristics thereof. The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. An object storage and transport mechanism for use in an automated, self-service machine, comprising:
a first mechanism configured to store a plurality of objects, and a second mechanism configured to transport objects between the first mechanism and a discharge location; the first and second mechanisms being operable together in at least two modes, including a retrieval mode and a return mode, wherein when in the retrieval mode said second mechanism retrieves an object from said first mechanism and transports the retrieved object to the discharge location, and when in the return mode said second mechanism returns an object from the discharge location to said first mechanism.

2. The object storage and transport mechanism of claim 1, wherein the objects are cards, the automated, self-service machine comprises a card issuing machine, and the discharge location comprises a card discharge slot.

3. The object storage and transport mechanism of claim 2, wherein the cards are badges.

4. The object storage and transport mechanism of claim 1, wherein the first mechanism comprises a plurality of separate storage locations, each storage location configured to store a plurality of objects.

5. The object storage and transport mechanism of claim 1, wherein the second mechanism transports objects along a first axis, and the first mechanism and the second mechanism are movable relative to one another along a second axis that is generally perpendicular to the first axis.

6. The object storage and transport mechanism of claim 5, wherein the first mechanism is configured so as to be movable relative to the second mechanism, and the first mechanism is movable vertically whereby the second axis is vertical.

7. The object storage and transport mechanism of claim 1, wherein each object includes a unique identifier, and further comprising a sensor assembly for sensing the unique identifier.

8. The object storage and transport mechanism of claim 7, wherein the sensor assembly is associated with the second mechanism.

9. An apparatus for issuing, allowing return of, and re-issuing an object, comprising:
a housing including a user interface;
an opening in the housing through which an object is dispensed to and returned by a user;
a storage area within the housing configured to store a plurality of objects; and
a transport mechanism configured to transport an object between the storage area and the opening to issue an object from the storage area through the opening and to permit return of the object from the opening back to the storage area.

10. The apparatus of claim 9, wherein the objects are cards, the apparatus comprises an automated, self-service card issuing machine, and the opening comprises a card discharge slot.

11. The apparatus of claim 10, wherein the cards are badges.

12. The apparatus of claim 9, wherein the storage area comprises a plurality of separate storage locations, each storage location configured to store a plurality of objects.

13. The apparatus of claim 9, wherein the transport mechanism transports objects along a first axis, and the storage area and the transport mechanism are movable relative to one another along a second axis that is generally perpendicular to the first axis.

14. The apparatus of claim 13, wherein the storage area is configured so as to be movable relative to the transport mechanism, and the storage area is movable vertically whereby the second axis is vertical.

15. The apparatus of claim 9, wherein each object includes a unique identifier, and the apparatus further comprises a sensor assembly for sensing the unique identifier.

16. The apparatus of claim 15, wherein the sensor assembly is associated with the transport mechanism.

17. A machine for issuing, allowing return of, and re-issuing a card, comprising:
a housing;
an issue and return opening formed in the housing;
a card storage mechanism disposed within the housing and configured to store a plurality of cards; and
means for transporting a card from the card storage mechanism to the issue and return opening to issue a card through the issue and return opening, and for transporting a returned card from the issue and return opening back into the card storage mechanism for later reissuing.

18. The machine of claim 17, wherein the card storage mechanism comprises a plurality of separate storage locations, each storage location configured to store a plurality of cards.

19. The machine of claim 17, wherein the means for transporting transports a card along a first axis, and the card storage mechanism and the means for transporting are movable relative to one another along a second axis that is generally perpendicular to the first axis.

20. The machine of claim 19, wherein the card storage mechanism is configured so as to be movable relative to the means for transporting, and the card storage mechanism is movable vertically whereby the second axis is vertical.
